(19) United States
(12) Patent Application Publication
(10) Pub. No.: US 2020/0265965 A1
(43) Pub. Date: Aug. 20, 2020

(54) Protective glove for shielding penetrating radiation

(71) Applicant: Omar Omar-Pasha, Lohmar (DE)

(72) Inventor: Omar Omar-Pasha, Lohmar (DE)

(21) Appl. No.: 16/647,916

(22) PCT Filed: Sep. 19, 2018
(86) PCT No.: PCT/EP2018/075366

§ 371 Date: Mar. 17, 2020

(30) Foreign Application Priority Data
Sep. 21, 2017 (DE) 20 2017 105 744.5

(51) Int. Cl. G21F 3/035

(52) U.S. Cl. CPC G21F 3/035

(57) ABSTRACT

The invention relates to a protective glove for shielding penetrating radiation, having a radiation-inhibiting layer which at least partially surrounds the protective glove and is situated directly on the protective glove or is incorporated into the protective glove. The radiation-inhibiting layer is situated substantially on the extensor side of the protective glove, and the radiation-inhibiting layer, in the region of the fingers, decreases in thickness towards the flexor sides of the fingers over the course of the transverse direction of extent.

### CROSS REFERENCE TO RELATED APPLICATIONS

The present application is a 371 National Entry of International Patent Application No. PCT/EP2018/075366 filed Sep. 19, 2018, which claims priority to German Patent Application No. 202017105744.5 filed Sep. 21, 2017, both of which are incorporated by reference herein in their entirety.

### TECHNICAL FIELD

The invention relates to a protective glove for shielding penetrating radiation, having a radiation-inhibiting layer which at least partially surrounds the protective glove and is situated directly on the protective glove or incorporated into the protective glove.

### BACKGROUND

It is known that the risk of cancer is increased by exposure of the human body or parts of the human body to penetrating radiation, especially X-rays. State-of-the-art protective gloves are therefore known to protect against this penetrating radiation in a variety of designs.

Medical personnel, in particular radiologists and/or neurologists, are exposed to increased penetrating and therefore harmful radiation when carrying out medical examinations, such as operations performed with the aid of X-ray visualization, also known as fluoroscopic procedures. Particularly the upper extremities, such as the arms and fingers, are exposed to increased penetrating radiation.

In order to minimize the risk of radiation-induced illness of medical personnel, it is known to protect themselves against penetrating radiation with a shield, usually made of a lead-containing material.

Furthermore, gloves consisting of an elastomeric material are known in particular as so-called latex disposable gloves. These gloves meet high hygienic requirements for medical procedures and guarantee a high wearing comfort and a good sense of touch for the wearer, but they do not protect against penetrating radiation.

From U.S. Pat. No. 3,883,749, protective gloves are known to protect against penetrating radiation, which consist of an elastomer, which is provided with a shielding, mostly lead-containing substance. However, such protective gloves have the disadvantage that they are relatively thick. As a result, such protective gloves are relatively rigid and provide the wearing medical personnel limited tactile sensitivity, which severely restricts the sense of touch, especially in the finger pad area.

Furthermore, the production is relatively complex, so that such protective gloves are expensive to produce.

Furthermore, U.S. Pat. No. 5,638,545 discloses that in order to shield the upper extremities, in particular the hand exposed to penetrating radiation, the hand must be fitted with a cuff to be placed around the hand of medical personnel. The disadvantage of such cuffs is that they only shield the area of the back of the hand, but not the fingers of the hand, so that the fingers continue to be exposed to penetrating radiation. In addition, these cuffs are problematic in terms of wearing comfort, as they can slip and, due to their relatively high weight, can lead to rapid fatigue in the hand.

Considering this prior art, it is an object of the present invention to provide a protective glove which overcomes or improves the disadvantages known from the state of the art regarding the rigidity of the material and in particular the lack of tactile sensitivity in the finger pad area.

### SUMMARY

For technically solving this object the invention proposes a protective glove for shielding penetrating radiation having a radiation-inhibiting layer which at least partially surrounds the protective glove and is situated directly on the protective glove or is incorporated into the protective glove, which is characterised in that the radiation-inhibiting layer is situated substantially on the extensor side of the protective glove, and the radiation-inhibiting layer, in the region of the fingers, decreases in thickness towards flexor sides of the fingers over the course of the transverse direction of extent.

The invention is based on the findings that the tactile sensitivity or sense of touch is improved when using the protective gloves according to the invention, as the elastomeric material of the protective glove is minimally thin in the finger pad area. Sufficient protection against incoming radiation is guaranteed by the fact that the protective gloves according to the invention protect against radiation through the radiation-inhibiting layer during fluoroscopic procedures due to the directed propagation of the radiation. Furthermore, the mobility, particularly of the fingers, is improved, since the thickness of the radiation-inhibiting layer in the finger area decreases in the course of the transverse direction of extent towards the flexor sides of the fingers. A further result of this is that the protective gloves are lighter in weight, which additionally improves the wearing comfort. In addition, the amount of the radiation-inhibiting layer on a protective glove can be reduced, which allows for a more cost-effective production compared to the protective gloves known from the state of the art.

An embodiment of the invention is characterized in that the radiation-inhibiting layer is oriented towards incident radiation in a working position of the glove. Incident and penetrating radiation, in particular X-rays, as used in fluoroscopic procedures, generally strike a patient perpendicularly in the direction of the floor. During neurological or radiological medical procedures, the patient is usually in a horizontal position, so that an examiner can easily access the patient. In the radiation zone of the fluoroscopic procedure, it is therefore necessary for the examiner to hold his or her in particular extremities, such as the arms and hands, between the patient and the radiation source in order to be able to perform the medical procedure. The examiner usually holds the necessary equipment in a working position, for example similar to a typical pencil holding position. Due to the vertical incidence of the radiation, the radiation-inhibiting layer according to the design of the invention is arranged on the protective glove in such a way that the radiation-inhibiting layer has its greatest thickness and thus the greatest possible attenuation of the incoming and penetrating radiation to protect a hand wearing the protective glove in the working position.

Another embodiment of the invention is characterized in that the thickness of the radiation-inhibiting layer in the regions of the fingers decreases in thickness in the course of the longitudinal direction of extent from the finger roots to the fingertips.

As a result, the thickness of the radiation-inhibiting layer can decrease in the course of the fingers, both in the transverse direction of extent and in the longitudinal direction of extent.

This has the advantage of increasing the mobility of the hand in the protective glove. In addition, the protective glove becomes lighter, which significantly improves the wearing comfort, especially during long-term medical procedures.

A preferred embodiment of the invention provides that the areas of the finger pads are excluded from the radiation-inhibiting layer. The advantage of this is that an examiner is enabled to have an optimal sense of touch during a medical procedure, since only the layer of the ordinary material consisting of an elastomer is used for hygienic reasons. The protection against penetrating radiation continues to exist, since the radiation-inhibiting protective layer is essentially aligned on the extensor side of the fingers against the incoming radiation. In a further embodiment of invention, the entire fingertip of the fingers is excluded from the radiation-inhibiting layer, i.e. both in the area of the finger pad on the flexor side of a finger and in the area of the fingernail on the extensor side of a finger.

In a further embodiment of the invention, the radiation-inhibiting layer is arranged on the extensor side and partially on the flexor side of the glove and respectively surrounds the finger to be protected in an approximately semi-circular shape.

In an advantageous embodiment the radiation-inhibiting layer consists of a material containing lead. For example, the radiation-inhibiting layer may be a separate additional layer of elastomeric material and form part of the inventive glove, for example by being placed directly on top of the ordinary glove, or the glove may be coated with elastomer so that the radiation shielding layer is an inner layer. In addition, the inventive protective glove can advantageously consist of a matrix material. This comprises an elastomer and another material containing lead, so that these two materials form a matrix-like composition.

### BRIEF DESCRIPTION OF THE DRAWINGS

Further details, features and advantages of the invention are explained below with respect to the embodiments shown in the figures. It shows:

FIG. 1a shows a cross-sectional view of a finger to illustrate the positional indications;

FIG. 1b shows a cross-sectional view of an embodiment of the invention in the area of the fingers of the protective glove;

FIG. 2a shows a sectional view in the longitudinal direction in the area of the fingers of an embodiment of a protective glove according to the invention;

FIG. 3a shows a sectional view in the longitudinal direction of extent of a further embodiment of a protective glove according to the invention;

FIG. 4a shows the arrangement of the radiation-inhibiting layer in the area of the fingers in a top view of an embodiment of a protective glove according to the invention;

FIG. 4b shows the arrangement of the radiation-inhibiting layer according to FIG. 4a in a cross-sectional view; and

FIG. 4c shows the arrangement of the radiation-inhibiting layer in the area of the thumb of the embodiment of the protective glove according to FIG. 4a in a cross-sectional view.

### DETAILED DESCRIPTION

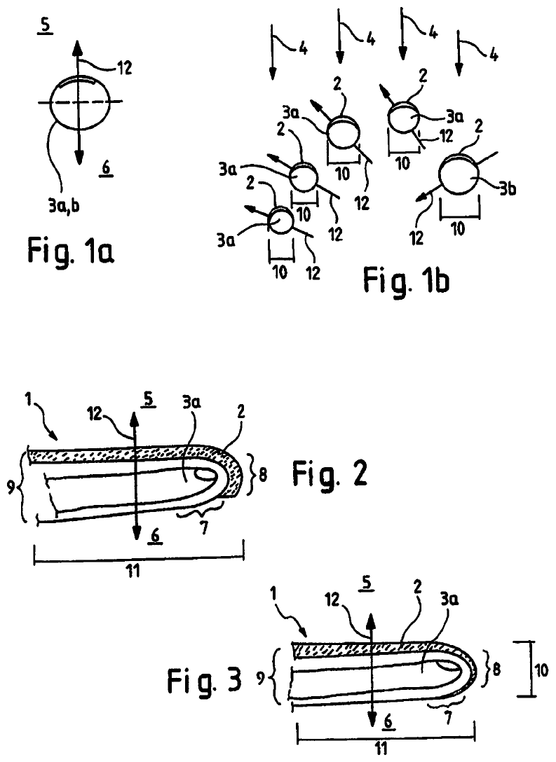

FIG. 1a shows a cross-sectional view of a finger, which can represent a long or small finger or a thumb. FIG. 1a shows the fingernail of the long/small finger or thumb 3a, b. The vertical double arrow with the reference sign 12 illustrates the bending or stretching of the long/small fingers or thumb 3a, b. Accordingly the extensor side of the long/small finger or thumb 3a, b with the reference sign 5 is above the long/small finger or thumb 3a, b and the flexor side 6 below the finger 3a, b.

FIG. 1b shows a cross-sectional view of a protective glove 1 according to the invention for shielding penetrating radiation 4 with a radiation-inhibiting layer 2 at least partially surrounding the protective glove 1. The radiation-inhibiting layer 2 is arranged directly on the protective glove 1 or embedded in the protective glove 1. The radiation-inhibiting layer 2 is essentially arranged on the extensor side 5 of protective glove 1. The arrows with the reference sign 12 shown at the small/long fingers or the thumb 3a, b, respectively, indicate the bending or stretching of the respective fingers 3a, b, and it can be seen that the respective radiation-inhibiting layer 2 is arranged at the small/long fingers or the thumb 3a, b oriented in such a way that the radiation-inhibiting layer 2 of the respective fingers 3a, b have their greatest strength or thickness with respect to incident radiation 4, presently X-rays. In this way, the radiation-inhibiting layer 2 is oriented towards the incident radiation 4 in a working position of the protective glove 1.

Furthermore, it can be seen that the radiation-inhibiting layer 2 in the area of the fingers 3a, b decreases in thickness in the direction of the transverse direction of extent 10 towards the flexor sides 6 of the fingers 3a, b.

The incident radiation 4 is shown in FIG. 1b arriving vertically from above, as is the case in medical procedures with a fluoroscopic zone.

FIG. 2 shows a longitudinal sectional view of a finger 3a, b, which is arranged in an embodiment of a protective glove according to the invention. Presently a small/long finger 3a is shown in the protective glove 1. The longitudinal direction of extent 11 of the long/small finger 3a is illustrated by the marking with the reference sign 11. On the flexor side 6 of the protective glove 1 surrounding the small/long finger 3a the area of the finger cap 7 is excluded from the radiation-inhibiting layer 2. This is essentially only on the extensor side 5 of the protective glove 1 and its thickness is essentially constant over the course in the longitudinal direction of extent 11 of the small/long fingers 3a.

The thickness or height of the radiation-inhibiting layer 2 in this case is about 0.75 mm to about 1.6 mm.

In contrast to this, FIG. 3 shows that the thickness of the radiation-inhibiting layer 2 in the area of the shown small/long finger 3a decreases in the course of the longitudinal direction of extent 11 from the finger root 9 to the fingertip 8. In the region of the finger root 9, the thickness or height of the radiation-inhibiting layer is about 1.6 mm, whereby it decreases towards the region of the fingertip 8 essentially to a thickness or height of about 0.75 mm. According to the embodiment shown in FIG. 2 the area of the finger cap 7 is excluded from the radiation-inhibiting layer 2.

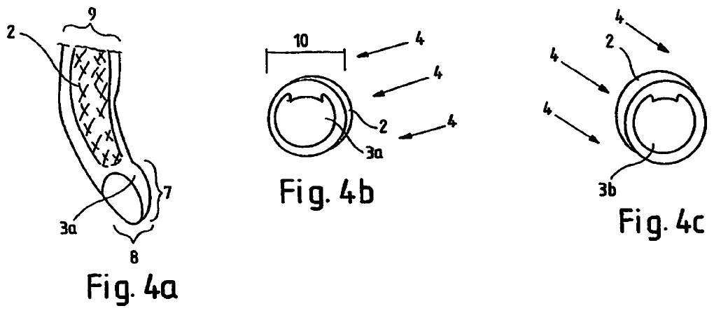

FIG. 4a shows a top view of a small/long finger 3a in an enlarged view of the corresponding FIG. 4b, whereby it can be seen that the radiation-inhibiting layer 2 is arranged over the entire length of the small/long finger 3a from finger root 9 to fingertip 8. The area of the finger cap 7 is excluded from the radiation-inhibiting layer 2.

FIG. 4b shows in an enlarged view that the radiation-inhibiting layer 2 surrounding the small/long finger 3a is located on the extensor side 5 and partly on the flexor side 6 and surrounds the small/long finger 3a to be protected in an approximately semi-circular shape. In addition, the radiation-inhibiting layer 2 is arranged in such a way that it is aligned with respect to incident radiation 4.

FIG. 4c shows the embodiment according to FIG. 4a, but instead of the small/long finger 3a the thumb 3b is shown. In contrast to the small/long finger 3a according to FIG. 4a or 4b, the radiation-inhibiting layer 2 is arranged on the opposite side of the finger of the protective glove 1, so that in a working position of the protective glove 1 the radiation-inhibiting layer 2 is aligned with incident radiation 4.

The embodiments shown and described in the figures are only intended to explain the invention and are not limiting.

### LIST OF REFERENCE NUMBERS

1 - protective glove
2 - radiation-inhibiting layer
3a - small/long finger
3b - thumb
4 - incident radiation
5 - extensor side
6 - flexor side
7 - finger pad
8 - fingertip
9 - finger root
10 - transverse direction of extent
11 - longitudinal direction of extent
12 - bending/stretching

What is claimed is:

1. A protective glove for shielding penetrating radiation, the glove comprising:
a radiation-inhibiting layer at least partially surrounding the protective glove and arranged directly on a material of the protective glove or incorporated into the material of the protective glove,
wherein the radiation-inhibiting layer is arranged substantially on an extensor side of the protective glove and, in a region of fingers of the glove, decreases in thickness towards flexor sides of the fingers continuously over a transverse direction of extent.

2. The protective glove according to claim 1, wherein the radiation-inhibiting layer is oriented towards incident radiation in a working position of the protective glove.

3. The protective glove according to claim 1, wherein the radiation-inhibiting layer in the region of the fingers decreases in thickness continuously over a longitudinal direction of extent from finger roots to fingertips.

4. The protective glove according to claim 1, wherein areas of finger pads are excluded from the radiation-inhibiting layer.

5. The protective glove according to claim 1, wherein areas of fingertips are excluded from the radiation-inhibiting layer.

6. The protective glove according to claim 1, wherein areas of fingertips and finger pads are excluded from the radiation-inhibiting layer.

7. The protective glove according to claim 1, wherein the radiation-inhibiting layer is arranged on the extensor side of the protective glove and partially on the flexor sides of the fingers to that the fingers are surrounded in an approximately semi-circular shape.

8. The protective glove according to claim 1, wherein the radiation-inhibiting layer consists of a material comprising lead.

9. The protective glove according to claim 1, wherein the material of the protective glove is elastomeric.

10. The protective glove according to claim 9, wherein the radiation-inhibiting layer is incorporated into the material of the protective glove, wherein the radiation-inhibiting layer comprises lead.

11. The protective glove according to claim 1, wherein the radiation-inhibiting layer is arranged directly on the material of the protective glove and consists of a separate layer of an elastomeric material containing lead.

12. The protective glove according to claim 1, further comprising an additional elastomeric layer arranged over at least the radiation-inhibiting layer.

13. A protective glove for shielding penetrating radiation comprising:
a glove formed of an elastomeric material having a radiation-inhibiting layer comprising lead arranged either directly on the glove or incorporated into the elastomeric material of the glove,
wherein the radiation-inhibiting layer is arranged on an extensor side of the glove and, in a region of fingers of the glove, decreases in thickness towards flexor sides of the fingers continuously over a transverse direction of extent so that the fingers are surrounded in an approximately semi-circular shape.

14. The protective glove according to claim 13, wherein the radiation-inhibiting layer is oriented towards incident radiation in a working position of the protective glove.

15. The protective glove according to claim 13, wherein the radiation-inhibiting layer in a region of the fingers decreases in thickness continuously over a longitudinal direction of extent from finger roots to fingertips.

16. The protective glove according to claim 13, wherein areas of finger pads are excluded from the radiation-inhibiting layer.

17. The protective glove according to claim 16, wherein areas of fingertips are excluded from the radiation-inhibiting layer.

18. The protective glove according to claim 13, further comprising an additional elastomeric layer situated over at least the radiation-inhibiting layer.

19. The protective glove according to claim 13, wherein the radiation-inhibiting layer is incorporated into the elastomeric material of the glove.

20. The protective glove according to claim 13, wherein the radiation-inhibiting layer is arranged directly on the elastomeric material of the glove and consists of a separate layer of an elastomeric material containing lead.
